(19) United States
(12) Patent Application Publication
(10) Pub. No.: US 2014/0301105 A1
(43) Pub. Date: Oct. 9, 2014

(54) BACK LIGHT UNIT WITH LIGHT GUIDE PLATE PREVENTING DARK AREA BETWEEN LEDS

(71) Applicant: HB TECHNOLOGY CO., LTD., Asan-si (KR)

(72) Inventors: Choongyop RHEW, Hwaseong-si (KR); Daisoung PARK, Hwaseong-si (KR); Seungkeun LEE, Hwaseong-si (KR)

(73) Assignee: HB TECHNOLOGY CO., LTD., Asan-si (KR)

(21) Appl. No.: 14/212,350

(22) Filed: Mar. 14, 2014

(30) Foreign Application Priority Data
Apr. 8, 2013 (KR) 10-2013-0038221

(51) Int. Cl. F21V 8/00

(52) U.S. Cl. CPC G02B 6/0018; G02B 6/0073
USPC 362/608

(57) ABSTRACT

A backlight unit with a light guide plate preventing the dark area between light emitting diodes (LEDs) is provided, wherein a plurality of dark area-preventing patterns formed on an incidence plane of a light guide plate and having different angles of inclination or different radii of curvature may evenly diffuse lights incident from an LED even under the condition that the gap between the LEDs is relatively broad and greater than or equal to the width of an LED and thus, uniform brightness may be obtained without an occurrence of a dark area. Accordingly, the number of the LEDs may be decreased and the backlight unit may be fabricated with a relatively low cost.

### CROSS REFERENCE

Applicant claims foreign priority under Paris Convention to Korean Patent Application No. 10-2013-0038221 filed 8 Apr. 2013, with the Korean Intellectual Property Office, where the entire contents are incorporated herein by reference.

### BACKGROUND OF THE INVENTION

1. Field of the Invention

The present invention relates to a backlight unit with a light guide plate preventing a dark area between light emitting diodes (LEDs), and more particularly, to technology for forming, on an incidence plane of a light guide plate adjacent to an LED of an edge light type backlight unit, a plurality of dark area-preventing patterns having different angles of inclination or different radii of curvature and for obtaining uniform brightness without an occurrence of a dark area.

2. Description of the Related Art

In general, a light guide plate may refer to a plate providing a path through which lights irradiated from a light source are uniformly scattered and diffused and be applicable to a backlight unit (BLU) used for a light-receiving flat panel display, e.g. a liquid crystal display, or a luminous signboard.

For example, Japanese Patent Laid-Open Publication No. 2004-325959 discloses a liquid crystal backlight device using a conventional backlight device by which lights incident from an LED to a light guide plate may be reflected upwards by a fine reflection pattern formed on a lower plane of the light guide plate and be emitted to a liquid crystal panel on an upper portion of the light guide plate through a diffuser.

However, because most of the light irradiated from the LED may proceed frontward and thus, a relatively small amount of the light may proceed laterally the light irradiated from the LED may be non-uniformly provided to the light incidence plane of the light guide plate and accordingly, a dark area may be formed between the LEDs and non-uniform brightness may ensue.

Thus, it may be required to dispose the LEDs at a narrower interval to prevent an occurrence of the dark area, which may incur a higher cost and cause limitations in design.

When the light efficiency of an LED increases, the number of LEDs disposed on a side plane of the light guide plate may decrease. However, when the number of the LEDs decreases, a gap between the LEDs may be larger and consequently, brightness may become uneven further.

To solve such an issue, technologies for forming a saw-toothed pattern on an incidence plane of the light guide plate for a conventional small-sized mobile device or a monitor have been introduced.

When applying the technology to a large-sized television (TV) whose size exceeds that of displays for ordinary PC sets, instruments, medical devices, etc., the gap between the LEDs may be required to be much larger. However, the conventional simple saw-toothed pattern may not adequately eliminate a dark area and cause a secondary issue of non-uniform illumination intensity of a surface light source due to the change in the process condition for the saw-toothed pattern.

Accordingly, to provide a large-sized backlight unit in a more economically efficient manner, there is a desire for a technology for allowing a light guide plate to evenly diffusing the light incident from LEDs even under the condition that the gap between the LEDs is relatively large, which may be greater than or equal to the width of an LED, and for preventing an occurrence of a dark area.

### SUMMARY OF THE INVENTION

The intent of the present invention, for the purpose of solving the drawbacks aforementioned, is to provide, even under the condition that the gap between LEDs is relatively large, which may be greater than or equal to the width of the LED, lights incident from an LED that are to be evenly diffused by a light guide plate and thus, and thus, uniform brightness that is to be obtained without an occurrence of a dark area with the result that the number of the LEDs may decrease and a large-sized backlight unit may be fabricated with a low cost.

To achieve the said goals, the present invention shall provide a backlight unit including a plurality of LEDs disposed on a bar-shaped circuit board and separated from one another at a predetermined interval and a light guide plate in which a plurality of dark area-preventing pattern groups are repetitively formed on an incidence plane adjacent to the LED to prevent a dark area between the LEDs, where a plurality of dark area-preventing patterns shall be formed in each of the dark area-preventing pattern groups so that the lights incident from the LED are refracted at different refraction angles to be diffused.

The gap between the LEDs may have a size greater than or equal to the width of the LED.

The dark area-preventing patterns having different inclination angles or different radii of curvature may be formed in each of the dark area-preventing pattern groups.

A plurality of saw-toothed dark area-preventing patterns having different inclination angles with respect to the incidence plane of the light guide plate may be formed in a dark area-preventing pattern group.

A plurality of elliptical dark area-preventing patterns having different radii of curvature with respect to the incidence plane of the light guide plate may be formed in the dark area preventing pattern group.

The dark area-preventing patterns having different inclination angles or different radii of curvature may be formed in each of the dark area-preventing pattern groups, where the number of a pattern is to, or not to, be identical to that of.

The dark area-preventing patterns may be formed at a position within the radiation angle, which corresponds to each LED, at which the light incident from each LED is dispersed and reached.

The dark area-preventing patterns may be formed using at least one of laser processing, hot stamping, injection molding, and ultrasonic machining.

According to the present invention, lights incident from an LED may be evenly diffused by a plurality of dark area-preventing patterns formed on an incidence plane of a light guide plate and having different angles of inclination or different radii of curvature, even under the condition that the gap between LEDs is relatively broad and greater than or equal to the width of the LED and thus, uniform brightness may be obtained without an occurrence of a dark area. Accordingly, the number of the LEDs may decrease and a large-sized backlight unit may be fabricated with a low cost.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1A is a planar view of the core part of a backlight unit illustrating a light guide plate 300 and LEDs (L) according to the Embodiment 1 of the present invention;

FIGS. 1B through 1D are diagrams illustrating a light diffusing and dark area-preventing effect based on the inclination angles (θ1, θ2) of the dark area preventing-patterns (G1, G2) in a light guide plate 300 illustrated in FIG. 1A;

FIGS. 1E and 1F are diagrams illustrating a relationship between the width (W) and the pitch (P) of the dark area-preventing patterns (G1, G2) in the light guide plate 300 illustrated in FIG. 1A;

FIG. 2 is a planar view of the core part of a backlight unit, illustrating a light guide plate 400 and LEDs (L) according to the Embodiment 2 of the present invention;

FIG. 3 is a planar view of the core part of a backlight unit, illustrating a light guide plate 500 and LEDs (L) according to the Embodiment 3 of the present invention;

FIG. 4 is a planar view of the core part of a backlight unit, illustrating a light guide plate 600 and LEDs(L) according to the Embodiment 4 of the present invention; and

FIG. 5 is a planar view of the core part of a backlight unit, illustrating a light guide plate 700 and LEDs(L) according to the Embodiment 5 of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout.

When it is determined a detailed description related to a related known function or configuration that may make the purpose of the present invention unnecessarily ambiguous in describing the present invention, the detailed description will be omitted here.

### Embodiment 1

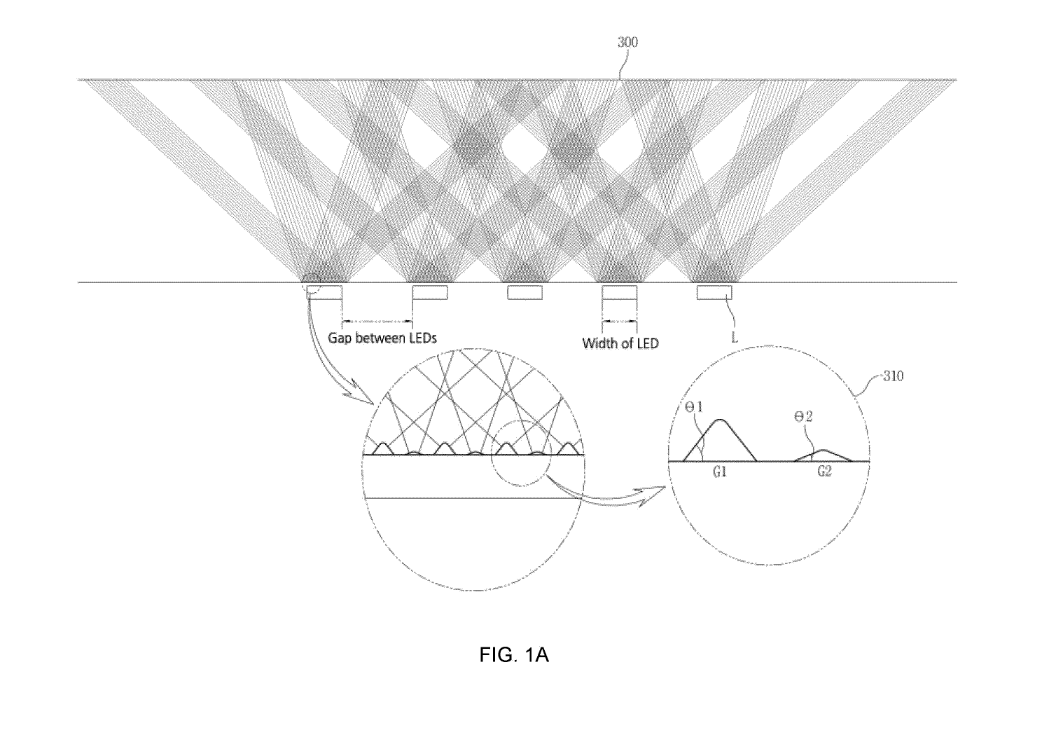

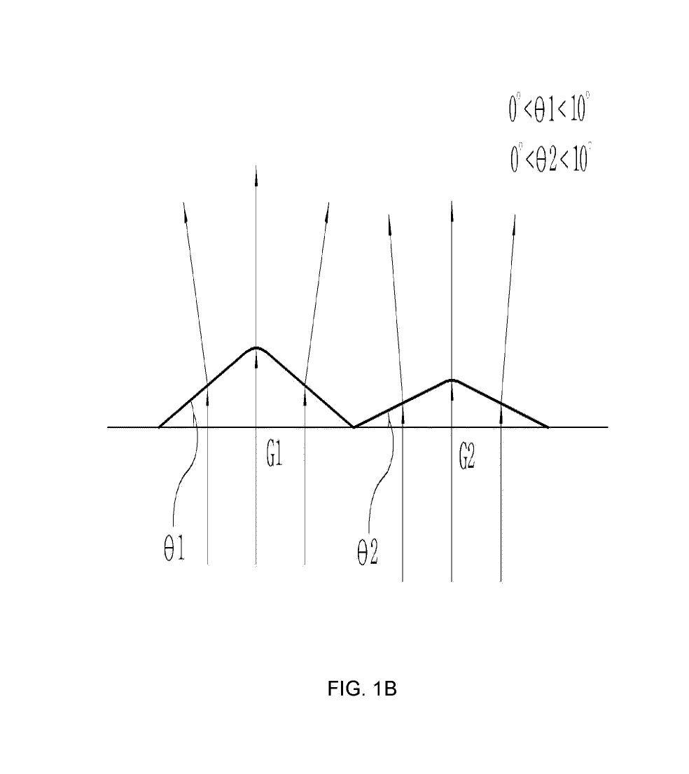

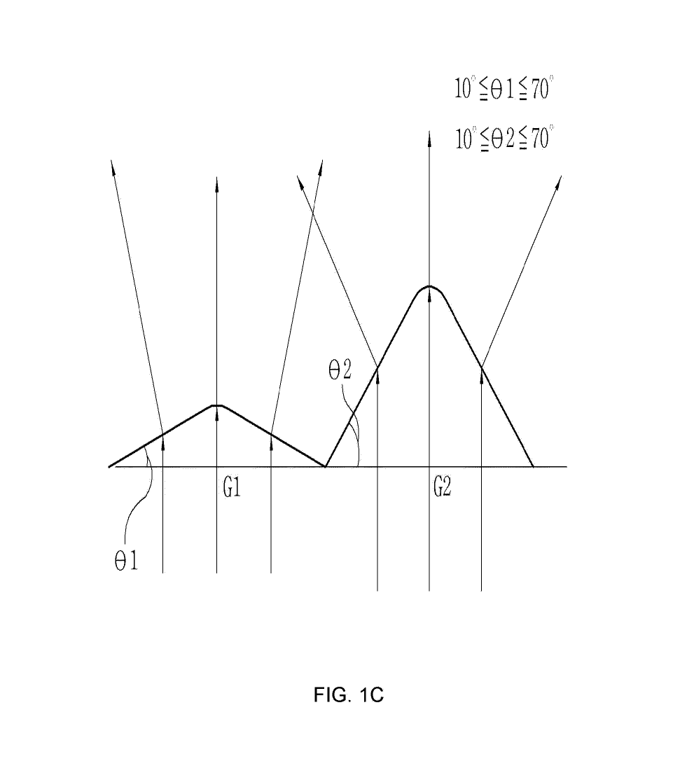

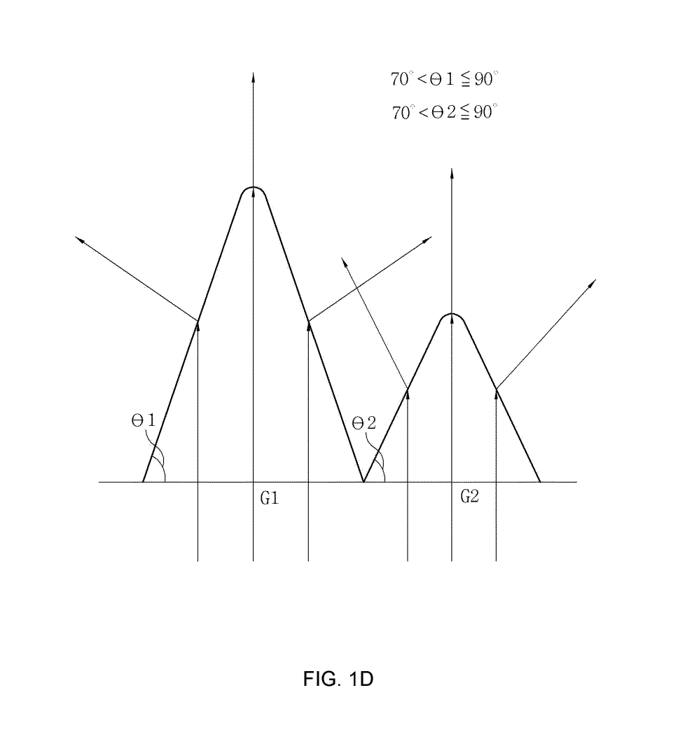

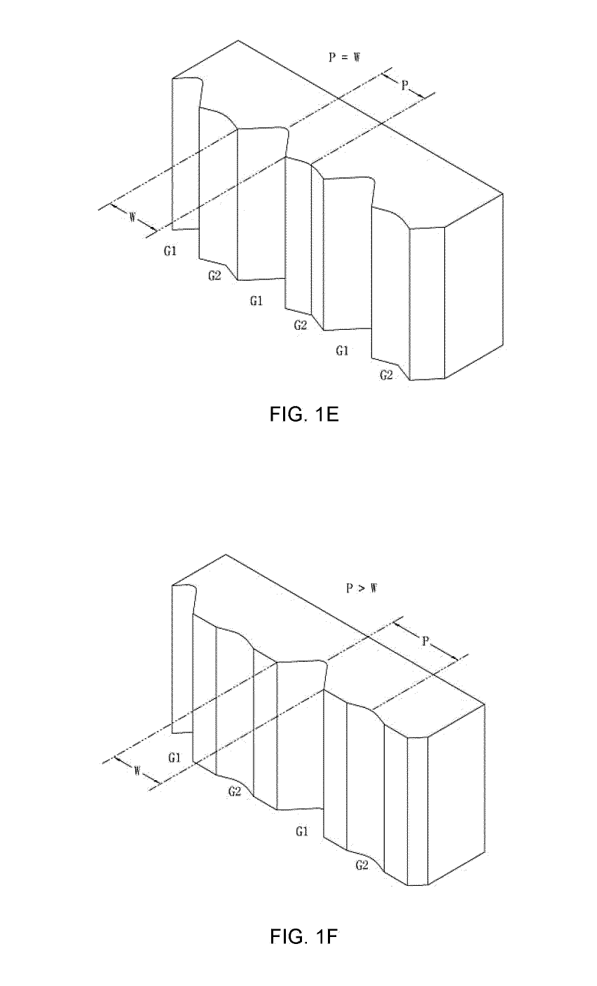

FIG. 1A is a planar view of a backlight unit, illustrating a light guide plate 300 and an LED(L) according to the Embodiment 1 of the present invention; FIGS. 1B through 1D are diagrams illustrating a light diffusing and dark area-preventing effect based on the inclination angles (θ1, θ2) of the dark area preventing patterns (G1, G2) in a light guide plate 300 illustrated in FIG. 1A; and FIGS. 1E and 1F are diagrams illustrating a relationship between the width (W) and the pitch (P) of dark area-preventing patterns (G1, G2) in the light guide plate 300 illustrated in FIG. 1A.

Referring to FIG. 1A, the backlight unit according to the Embodiment 1 of the present invention shall include a plurality of dark area-preventing pattern group 310 repetitively formed on an incidence plane of the light guide plate 310 adjacent to the LED (L) to prevent an occurrence of a dark area.

Here, the light guide plate 300 shall be formed with transparent synthetic resin allowing a light to penetrate, for which a combination of at least one of high-transparent silicon resin, urethane, polystyrene (PS), polycarbonate (PC), polyethylene terephthalate (PET), styrene methyl methacrylate (MS), and polymethylate (PMMA) may be used.

The said LEDs (L) may be disposed on a bar-shaped circuit board (not shown) and separated from one another at a predetermined interval. The side plane facing the LED light source (L) among the planes of the light guide plate 300, shall become the incidence plane while its upper plane of the light guide plate 300 shall be the emission plane. Also, light guide patterns (not shown) shall be formed on the lower plane of the light guide plate 300 to reflect an incident light toward a liquid crystal panel (not shown) and change the light to a surface light source.

Saw-toothed dark area-preventing patterns (G1, G2) having different inclination angles (θ1, θ2) shall be formed in the dark area-preventing pattern group 310 based on the incidence plane of the light guide plate 300.

Here, the dark area-preventing patterns (G1, G2) corresponding to the multiple LED light sources (L) shall be formed exclusively at a position within the radiation angle at which the light incident from each LED (L) is dispersed and reached but not at a position in the gap between the LEDs (L), where the light incident from the LED (L) is not directly reached in order to minimize the number of the patterns to be processed and the processing time consumed for it.

When the dark area preventing pattern group 310 is repetitively formed on the incidence plane of the light guide plate 300, the light incident from the LED light source (L) is to be refracted at a greater angle in the incidence plane by the saw-toothed dark area-preventing patterns (G1, G2) having different inclination angles (θ1, θ2). Accordingly, even when the gap between the LEDs (L) becomes larger, the light incident from the LED (L) may be more evenly diffused while passing the inside of the light guide plate 300 and thus, uniform brightness may be obtained without an occurrence of a dark area.

Here, the gap between the LEDs (L) is preferred to have a size greater than or equal to the width of each LED (L).

In a case of a backlight unit applicable to a TV of a large size surpassing that of displays for ordinary PC sets, instruments, medical devices, etc the size of a monitor, when the gap between the LEDs (L) increases, although a conventional simple saw-toothed pattern may not completely eliminate the dark area, the light incident from the L may be refracted at different refraction angles to be diffused by the saw-toothed dark area-preventing patterns (G1, G2) having different inclination angles (θ1, θ2) and thus, uniform brightness may be obtained without an occurrence of the dark area, according to the present invention.

Also, the dark area-preventing patterns (G1, G2) may be formed using at least one method of laser processing, hot stamping, injection molding, and ultrasonic machining and be formed to have inclination angles (θ1, θ2) of 10 to 70 degrees, about which a more detailed description will be provided with reference to FIGS. 1B through 1D.

Referring to FIG. 1B, when the dark area-preventing patterns (G1, G2) have inclination angles (θ1, θ2) less than 10 degrees, the light incident from the LED light source (L) may be hardly refracted and proceed straight due to the small refraction angle and thus, a dark area may occur in the gap between the LED (L) and the brightness may become non-uniform.

Referring to FIG. 1C, when the dark area-preventing patterns (G1, G2) have inclination angles (θ1, θ2) of 10 to 70 degrees, the diffusion amount of the light incident from the LED (L) may increase due to the increased refraction angle and thus, uniform brightness may be obtained without an occurrence of the dark area.

Referring to FIG. 1D, when the dark area-preventing patterns (G1, G2) have inclination angles (θ1, θ2) greater than 70 degrees, the light incident from the LED (L) may be overlapped, despite of the large refraction angle, and thus, an issue of hot spot may occur.

Based on the results of the foregoing experiments, it may be required to form dark area-preventing patterns (G1, G2) having inclination angles (θ1, θ2) of 10 to 70 degrees in order to allow the light incident from the LED (L) to be evenly dispersed without an occurrence of the dark area or the hot spot.

Although the dark area-preventing patterns (G1, G2) may be formed adjacent to each other as showns in FIGS. 1E and 1F in a way that the width (W) be identical to or larger than the pitch (P), with a predetermined clearance in between, it may be required to adequately adjust the width (W) and the pitch (P) to prevent the occurrence of the dark area or the hot spot caused by the overlapping of the incident lights.

### Embodiment 2

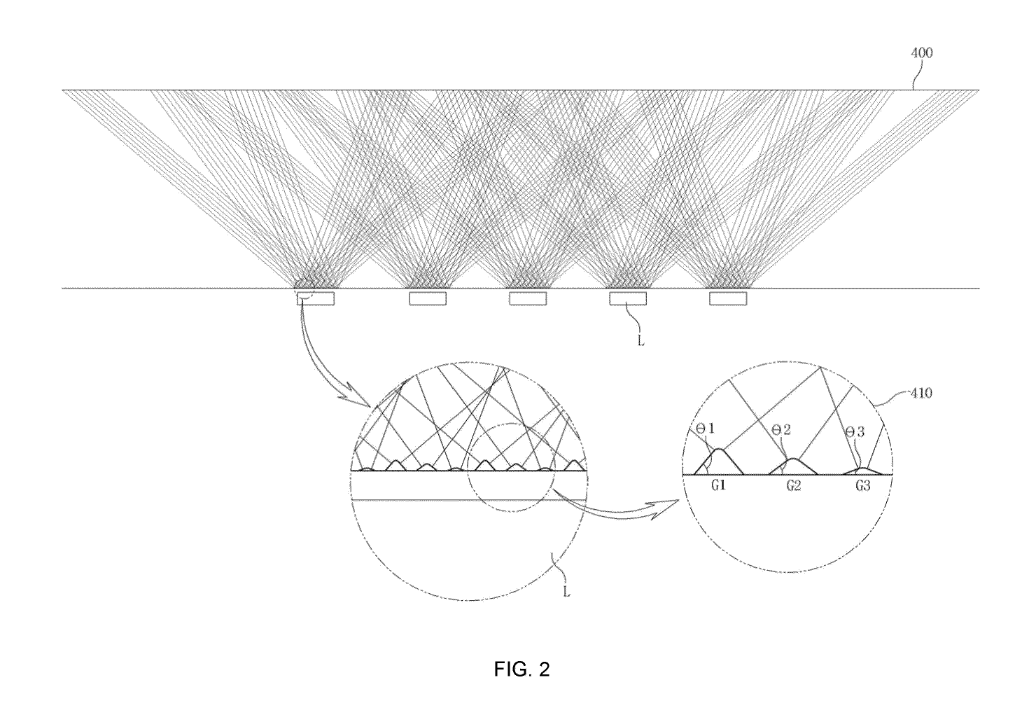

FIG. 2 is a planar view of the core part of a backlight unit, illustrating a light guide plate 400 and LEDs (L) according to the Embodiment 2 of the present invention.

Referring to FIG. 2, the backlight unit according to the Embodiment 2 of the present invention may be identical to the backlight unit illustrated in FIG. 1A except those facts that a plurality of dark area preventing-pattern groups 410 shall be repetitively formed on an incidence plane of the light guide plate 400 and saw-toothed dark area-preventing patterns (G1, G2, G3) having three different inclination angles (θ1, θ2, θ3) shall be formed in the dark area-preventing pattern group 410.

When the saw-toothed dark area-preventing patterns (G1, G2, G3) having three different inclination angles (θ1, θ2, θ3) are repetitively formed on the incidence plane of the light guide plate 400, lights are diffused by the dark area preventing patterns (G1, G2, G3) having three different inclination angles (θ1, θ2, θ3) after being refracted at angles of which number is larger than those in the case of the dark area-preventing patterns (G1, G2) having two different inclination angles (θ1, θ2), by which the amount of light diffusion may increase and thus, a more uniform brightness may be obtained without an occurrence of a dark area.

Although a description of the dark area-preventing patterns (G1, G2, G3) formed in the dark area-preventing pattern group 410 with three different inclination angles (θ1, θ2, θ3) is provided here, the number and arrangement of the dark area-preventing patterns (G1, G2, G3) included in the dark area-preventing pattern group 410 may be liberally changed as a need arises.

### Embodiment 3

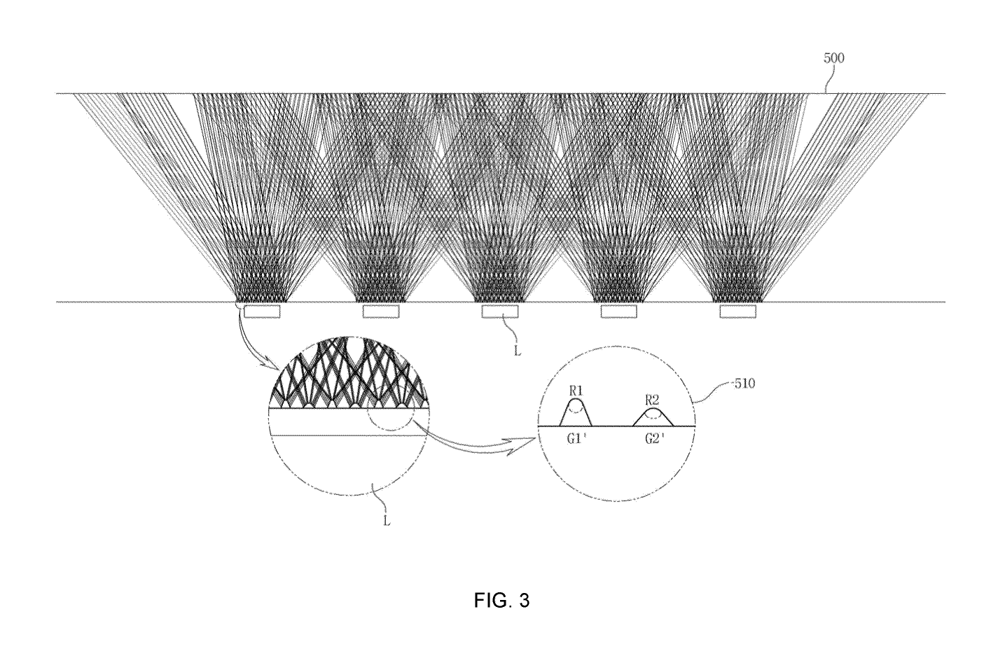

FIG. 3 is a planar view of the core part of a backlight unit, illustrating a light guide plate 500 and LEDs (L) according to the Embodiment 3 of the present invention.

Referring to FIG. 3, the backlight unit according to the Embodiment 3 of the present invention may be identical to the backlight unit illustrated in FIG. 1A except those facts that may include a plurality of dark area-preventing pattern groups 510 shall be repetitively formed on an incidence plane of the light guide plate 500 and elliptical dark area-preventing patterns (G1′, G2′) having different radii (R1, R2) of curvature shall be formed in the dark area-preventing pattern group 510.

Here, the dark area-preventing patterns (G1′, G2′) are preferred to be formed to have different radii (R1, R2) of curvature within a range of 30 μm to 200 μm using at least one method of laser processing, hog stamping, injection molding, and ultrasonic machining because if the radii (R1, R2) of curvature of the dark area-preventing patterns (G1′, G2′) are less than 30 μm, an extreme portion of lights emitted from the LED (L) may be used for diffusion and refraction and thus, its effect may be insignificant whereas if the radii (R1, R2) of curvature of the dark area-preventing patterns (G1′, G2′) exceed 200 μm, the average distance between the LED (L) and the incidence plane of the light guide plate 500 is to increase and thus, the light intensity may be reduced.

As shown in FIG. 3, when the elliptical dark area-preventing patterns (G1′, G2′) having different radii (R1, R2) of curvature are repeatedly formed on the incidence plane of the light guide plate 500, the lights incident from the LED (L) are to be refracted at different refraction angles and diffused by the elliptical dark area-preventing patterns (G1′, G2′) having the different radii (R1, R2) of curvature. Accordingly, the light incident from the LED (L) may be more evenly diffused while passing the inside of the light guide plate 500 and brightness may become more uniform without an occurrence of a dark area even when the gap between the LEDs (L) becomes larger.

### Embodiment 4

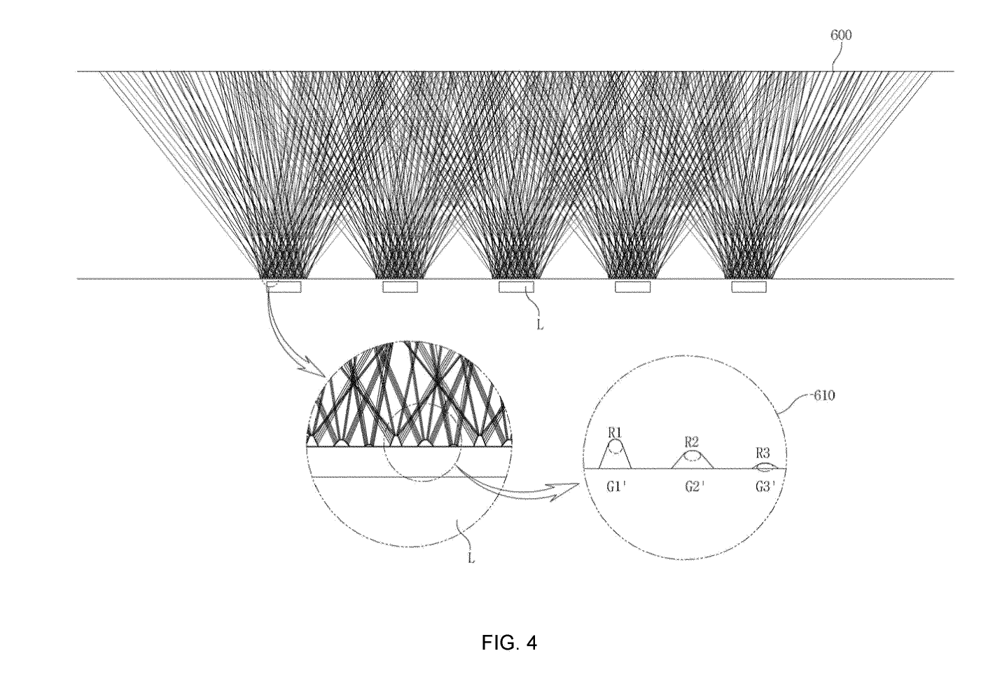

FIG. 4 is a planar view of the core part of a backlight unit, illustrating a light guide plate 600 and LEDs (L) according to the Embodiment 4 of the present invention.

Referring to FIG. 4, the backlight unit according to the Embodiment 4 of the present invention may be identical to the backlight unit illustrated in FIG. 3 except those facts that a plurality of dark area-preventing pattern groups 610 that shall be repeatedly formed on an incidence plane of the light guide plate 600 and elliptical dark area-preventing patterns (G1′, G2′, G3′) having different radii (R1, R2, R3) of curvature shall be formed in the dark area-preventing pattern group 610.

When the elliptical dark area-preventing patterns (G1′, G2′, G3′) having three different radii (R1, R2, R3) of curvature are repeatedly formed on the incidence plane of the light guide plate 600, lights are diffused by the dark area-preventing patterns (G1′, G2′, G3′) having three different radii (R1, R2, R3) of curvature after being refracted at angles of which number is larger than those in the case of the elliptical dark area preventing-patterns (G1′, G2′) having two different radii (R1, R2) of curvature, by which the amount of light diffusion may increase and thus, a more uniform brightness may be obtained without an occurrence of a dark area.

### Embodiment 5

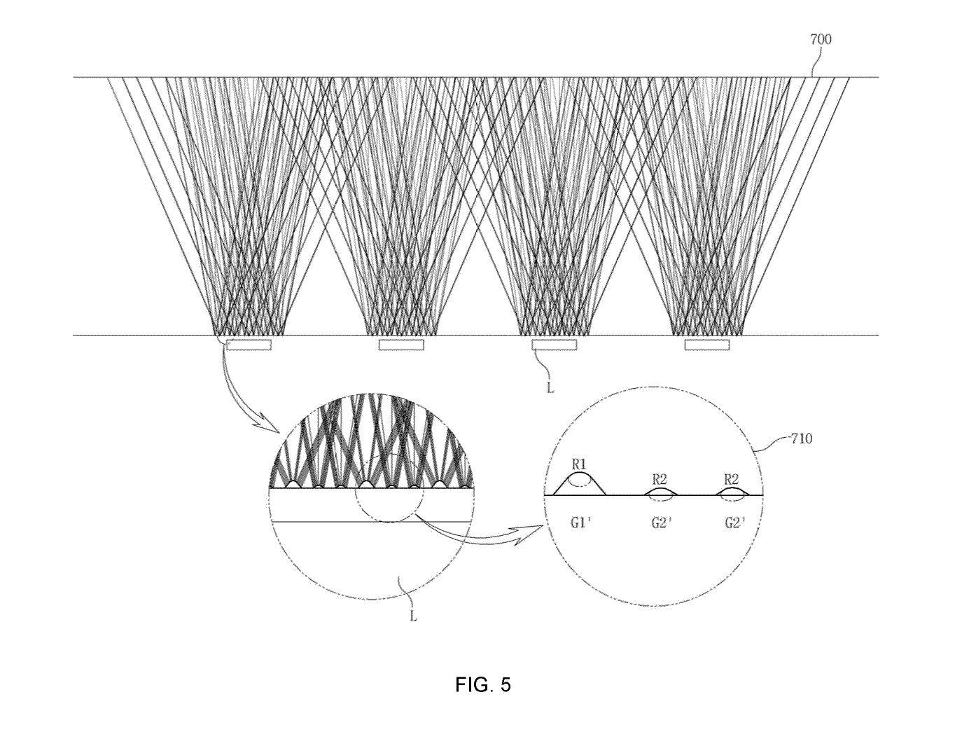

FIG. 5 is a planar view of the core part of a backlight unit, illustrating a light guide plate 700 and LEDs (L) according to the Embodiment 5 of the present invention.

Referring to FIG. 5, the backlight unit according to a further embodiment of the present invention may be identical to the backlight unit illustrated in FIG. 3 except those facts that a plurality of dark area-preventing pattern groups 710 shall be repeatedly formed on an incidence plane of the light guide plate 700 and number ratio of dark area preventing patterns (G1′) having the first radius (R1) of curvature to dark area preventing patterns (G2′) having the second radius (R2) of curvature is differently provided.

For example, the ratio of the number of dark area preventing patterns (G1′) having the first radius (R1) of curvature to the number of dark area preventing patterns (G2′) having the second radius (R2) of curvature may be differently provided, for example, 1:2 or 1:3. When the number ratio is differently provided as indicated in the foregoing, the brightness may become uniform without an occurrence of a dark area, the dispersion may become even due to the overlap by repetition in case of the pattern of which processing is more sensitive and the amount of light diffusion may be controlled by a quantity design condition in lieu of a process condition.

Although a few preferred Embodiments of the present invention have been shown and described, the present invention is not limited to the described Embodiments. Instead, it would be appreciated by those skilled in the art that changes may be made to these embodiments without departing from the principles and spirit of the invention, the scope of which is defined by the claims and their equivalents.

What is claimed is:

1. A backlight unit, comprising:
a plurality of light emitting diodes (LEDs) disposed on a bar-shaped circuit board and separated from one another at a predetermined interval; and
a light guide plate in which a plurality of dark area-preventing pattern groups are repetitively formed on an incidence plane adjacent to an LED to prevent a dark area between the LEDs,
wherein a plurality of dark area-preventing patterns are formed in each of the dark area-preventing pattern groups so that the lights incident from the LED are refracted at different refraction angles to be diffused.

2. The backlight unit of claim 1, wherein gap between the LEDs has a size greater than or equal to the width of the LED.

3. The backlight unit of claim 2, wherein the dark area-preventing patterns having different inclination angles or different radii of curvature are formed in each of the dark area-preventing pattern groups.

4. The backlight unit of claim 3, wherein a plurality of saw-toothed dark area-preventing patterns having different inclination angles are formed in a dark area-preventing pattern group based on the incidence plane of the light guide plate.

5. The backlight unit of claim 3, wherein a plurality of elliptical dark area-preventing patterns having different radii of curvature are formed in a dark area-preventing pattern group based on the incidence plane of the light guide plate.

6. The backlight unit of claim 3, wherein the dark area-preventing patterns having the different inclination angles or different radii of curvature are formed in each of the dark area preventing pattern groups with a ratio, which is or is not equal to 1, of the patterns with a curvature to the patterns with another curvature.

7. The backlight unit of claim 3, wherein the dark area-preventing patterns are formed at a position within a radiation angle at which a light incident from each LED is dispersed and reached corresponding to each LED.

8. The backlight unit of claim 3, wherein the dark area-preventing patterns are formed using at least one of laser processing, hot stamping, injection molding, and ultrasonic machining.
